(19) United States
(12) Patent Application Publication
(10) Pub. No.: US 2025/0074492 A1
(43) Pub. Date: Mar. 6, 2025

(54) WHEELED PLATFORM AND WHEELED PLATFORM SYSTEM

(71) Applicant: TOYOTA BOSHOKU KABUSHIKI KAISHA, Aichi (JP)

(72) Inventors: Hiroshi TSUJI, Nagoya-shi (JP); Fumitoshi AKAIKE, Miyoshi-shi (JP); Akari WATANABE, Aichi-gun (JP)

(73) Assignee: TOYOTA BOSHOKU KABUSHIKI KAISHA, Aichi (JP)

(21) Appl. No.: 18/809,621

(22) Filed: Aug. 20, 2024

(30) Foreign Application Priority Data
Aug. 30, 2023 (JP) 2023-139954

(51) Int. Cl. B62B 5/04; B62B 5/00; H01R 13/62; H01R 13/639

(52) U.S. Cl. CPC B62B 5/0495; B62B 5/0093; H01R 13/6205; H01R 13/639

(57) ABSTRACT

The wheeled platform of the present disclosure includes a base on which an object is placed; wheels attached to the base; a lock device having a latch that is lockable to a striker that is fixed; a guide member configured to guide the striker to a position where the striker is lockable to the latch; and a wheeled platform side terminal contactable with a fixed side terminal disposed on a member to which the striker is fixed, the wheeled platform side terminal being disposed at a position where the wheeled platform side terminal is contactable with the fixed side terminal when the latch locks the striker. The wheeled platform is configured such that the guide member comes in contact with the striker before the wheeled platform side terminal comes in contact with the fixed side terminal.

### CROSS-REFERENCE TO RELATED APPLICATIONS

This application claims the benefit of Japanese Patent Application No. 2023-139954 filed on Aug. 30, 2023 with the Japan Patent Office, the entire disclosure of which is incorporated herein by reference.

### BACKGROUND

The present disclosure relates to a wheeled platform and a wheeled platform system.

For example, a wheeled platform disclosed in Japanese Unexamined Patent Application Publication No. 2015-016779 includes fix mechanisms that are situated close to casters to restrict rotation of the casters.

### SUMMARY

The present disclosure discloses an example of a wheeled platform and a wheeled platform system that can, for example, supply electric power to an object placed on the wheeled platform in a case where an object, such as a refrigerator, that needs to be supplied with electric power is placed on the wheeled platform.

It is desirable that a wheeled platform includes at least one of the following elements, for example.

The elements are a base for placing an object; wheels attached to the base; a lock device having a latch that is lockable to a striker that is fixed; a guide member configured to guide the striker to a position where the striker is lockable to the latch; and a wheeled platform side terminal contactable with a fixed side terminal disposed on a member to which the striker is fixed, the wheeled platform side terminal being disposed at a position where the wheeled platform side terminal is contactable with the fixed side terminal when the latch locks the striker. The wheeled platform may be configured such that the guide member comes in contact with the striker before the wheeled platform side terminal comes in contact with the fixed side terminal.

Since the wheeled platform is thereby guided by the guide member and locked to the striker that is fixed at a given position, the position of the wheeled platform side terminal automatically matches with the position of the fixed side terminal. Accordingly, fixing of the wheeled platform and connection of the wheeled platform side terminal with the fixed side terminal are achieved at the same time.

The wheeled platform may be configured as follows, for example. When a direction in which the base is moved when the latch and the striker are locked to each other is a lock direction, the wheeled platform side terminal is slidable in the lock direction. And, it is desirable that the wheeled platform includes a spring configured to cause an elastic force in the lock direction to act on the wheeled platform side terminal. Accordingly, in the wheeled platform, it is possible to absorb dispersion of positions of the wheeled platform side terminal and the fixed side terminal in the lock direction.

In a state where the wheeled platform side terminal contacts the fixed side terminal and where the striker and the latch are locked to each other, it is desirable that the spring is elastically deformed. This enables enhancement of the contact surface pressure between the wheeled platform side terminal and the fixed side terminal in the wheeled platform.

It is desirable that the wheeled platform side terminal is slidable over a connection completed position to a position situated further in the backside direction. The connection completed position is a position of the wheeled platform side terminal when the wheeled platform side terminal contacts the fixed side terminal and when the striker and the latch are locked to each other. The backside direction is a direction from the fixed side terminal to the wheeled platform side terminal.

This can inhibit damages on the wheeled platform side terminal due to a large load acting on the wheeled platform side terminal when the wheeled platform side terminal largely deviates with respect to the fixed side terminal in a direction orthogonal to the lock direction.

It is desirable that the wheeled platform is configured such that a magnetic attraction force that enhances a contact surface pressure between the wheeled platform side terminal and the fixed side terminal is generated between a wheeled platform side terminal holder that holds the wheeled platform side terminal and a fixed side terminal holder that holds the fixed side terminal when the wheeled platform side terminal contacts the fixed side terminal.

This causes an elastic force of the spring and the magnetic attraction force to act on contact portions of the wheeled platform side terminal and the fixed side terminal, which enhances the contact surface pressure between the wheeled platform side terminal and the fixed side terminal, and therefore the wheeled platform side terminal and the fixed side terminal can be infallibly coupled to each other.

It is desirable that the wheeled platform side terminal holder is displaceable in directions orthogonal to the lock directions. Accordingly, even when the wheeled platform side terminal deviates with respect to the fixed side terminal in a direction orthogonal to the lock direction, such deviation can be absorbed.

In this case, even if the wheeled platform side terminal deviates with respect to the fixed side terminal in a direction orthogonal to the lock direction, the wheeled platform side terminal and the fixed side terminal can infallibly come in contact with each other.

Furthermore, it is desirable that the wheeled platform side terminal holder includes a recess in which a part of the fixed side terminal holder can be fitted and that a tapered portion is disposed at an entrance of the recess. It is also desirable that an opening area of the tapered portion increases toward the entrance of the recess.

Accordingly, even if the wheeled platform side terminal deviates with respect to the fixed side terminal in a direction orthogonal to the lock direction, the wheeled platform side terminal and the fixed side terminal can infallibly come in contact with each other.

### BRIEF DESCRIPTION OF THE DRAWINGS

Example embodiments of the present disclosure will be described hereinafter with reference to the accompanying drawings, in which:

FIG. 1 is a diagram showing a wheeled platform according to a first embodiment;

FIG. 2 is a diagram showing a structure of a wall;

FIG. 3 is a diagram showing a lock device, a guide member, and the like according to the first embodiment;

FIG. 4 is a diagram showing the lock device, and the like according to the first embodiment;

FIG. 5 is a diagram showing the lock device, the guide member, and the like according to the first embodiment;

FIG. 6 is a diagram showing the lock device, the guide member, and the like according to the first embodiment;

FIG. 7 is a diagram showing the lock device, the guide member, and the like according to the first embodiment;

FIG. 8 is a diagram showing the lock device, the guide member, and the like according to the first embodiment;

FIG. 9 is a diagram showing a power receiving device according to the first embodiment;

FIG. 10 is a diagram showing a relation between the power receiving device and the lock device in the first embodiment;

FIG. 11 is a diagram showing a relation between the power receiving device and the lock device in the first embodiment;

FIG. 12 is a diagram showing a relation between the power receiving device and the lock device in the first embodiment;

FIG. 13 is a diagram showing an upper surface side of the power receiving device in the first embodiment;

FIG. 14 is a diagram showing a fixed power receiving device according to the first embodiment;

FIG. 15 is a diagram showing the fixed power receiving device according to the first embodiment; and

FIG. 16 is a diagram showing a power receiving device according to a second embodiment.

### DETAILED DESCRIPTION OF EXEMPLARY EMBODIMENTS

The following “embodiments of the invention” represent examples of embodiments that fall within the technical scope of the present disclosure. In other words, matters to specify the invention or the like recited in the claims are not limited to any specific configuration, structure, or the like described in the following embodiments.

Arrows for indicating directions, oblique lines, or the like in each drawing are provided to facilitate understanding of mutual relations between the drawings, the shapes of members or portions, or the like. Therefore, orientation of a wheeled platform system specified in the present disclosure is not limited to how the wheeled platform system is oriented in each drawing.

With respect to a member or portion explained at least with a reference numeral, at least one of such a member or a portion is disposed unless it is described using a term such as “only one of”. The wheeled platform system of the present disclosure includes at least one of an element, such as a member or a portion explained at least with a reference numeral, or a structural component shown in the drawings.

### First Embodiment

### <1. Outline of Wheeled Platform System>

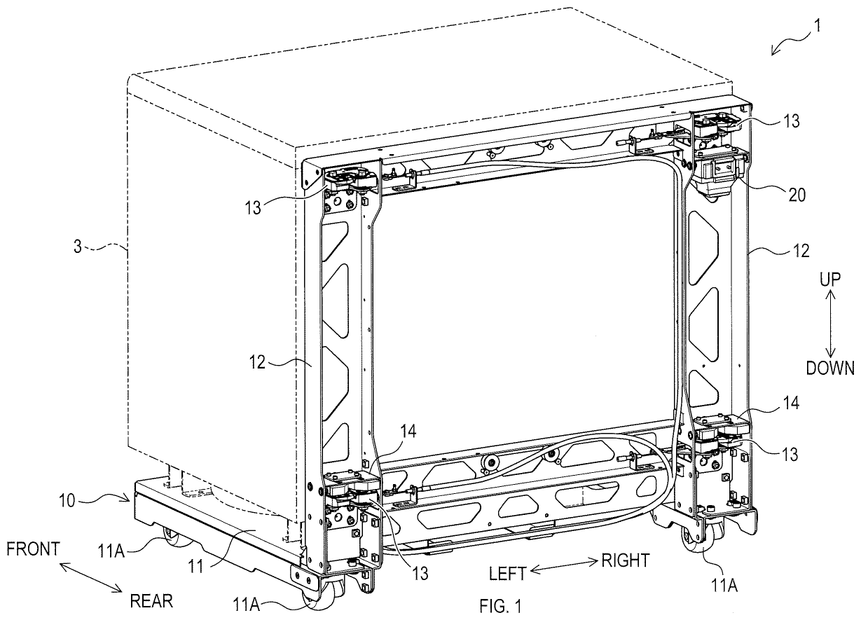

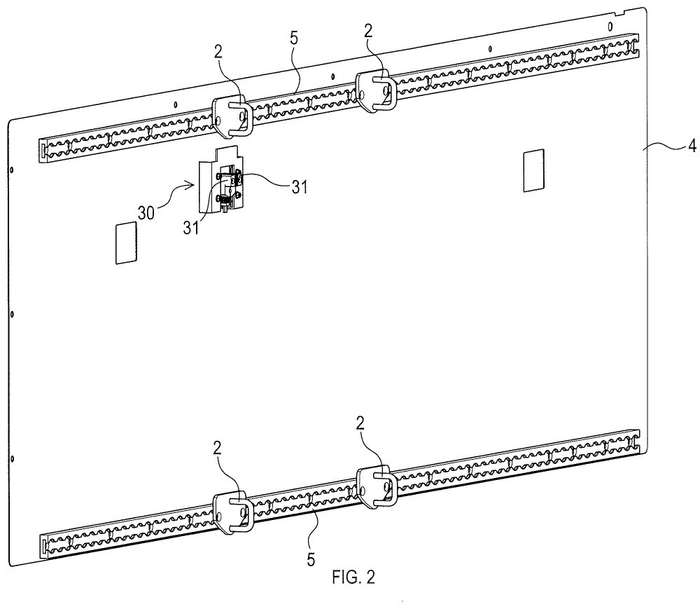

A wheeled platform system 1 according to the present embodiment is a system in which power supply from a power supply unit (not shown) to a wheeled platform 10 is enabled when the wheeled platform 10 (see FIG. 1) is locked to a striker 2 (see FIG. 2).

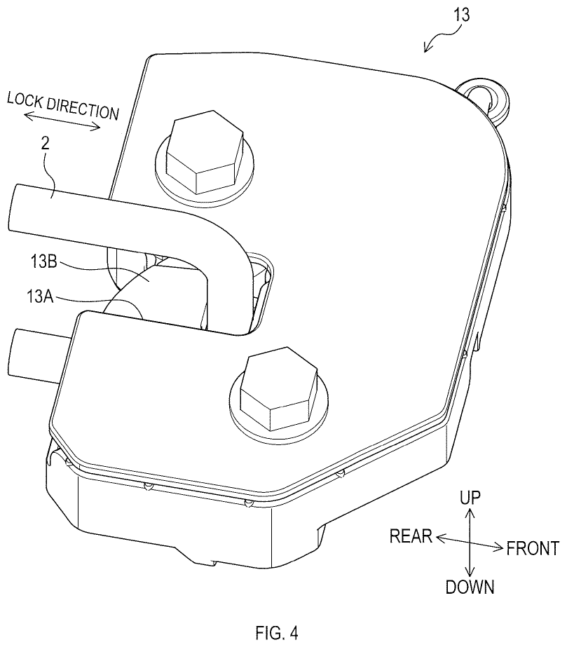

As shown in FIG. 2, the striker 2 is a substantially C-shaped locking wire that is fixed to a wall-like portion such as an inner wall of a vehicle (hereinafter referred to as wall 4). A portion of the striker 2 that engages with a latch 13B (see FIG. 4) extends in substantially vertical directions.

The striker 2 according to the present embodiment is fixed to the wall 4 via a fixing rail 5 such as an Airline rail (registered trademark). An object 3 (for example, appliance such as a refrigerator) can be placed on the wheeled platform 10 (see FIG. 1).

### <2. Details of Wheeled Platform>

As shown in FIG. 1, the wheeled platform 10 includes a base 11, a post 12, a lock device 13, a guide member 14, and a power receiving device 20. The base 11 is a portion on which the object 3 is placed. Wheels 11A are attached to the base 11.

The base 11 has a substantially rectangular plate-shape. The wheels 11A are individually disposed at positions corresponding to four corners of the base 11. Each of the wheels 11A is a so-called “swivel caster”. The swivel caster is a wheel with a shaft orientation that is freely displaceable by swiveling since the center line of the shaft and the center line of the swivel motion are twisted with respect to each other.

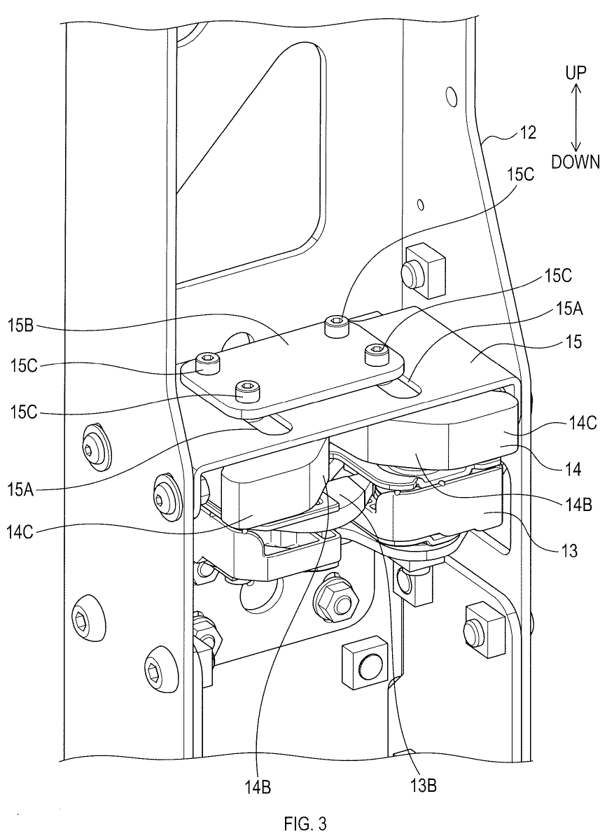

The post 12 is a pillar-like member rising from the base 11. In the present embodiment, two posts 12 are individually disposed at two corners of the base 11. Each of the posts 12 is substantially C-shaped with its rear side open (see FIG. 3).

In the present disclosure, as shown in FIG. 1, a portion of the wheeled platform 10 where the two posts 12 are disposed is called a rear side. A portion of the wheeled platform 10 opposite the rear side across the base 11 or the object 3 is a front side.

### <2.1 Lock Device>

The lock device 13 can be engaged with the striker 2 so as to hold the striker 2. As shown in FIG. 4, the lock device 13 includes a recess 13A and the latch 13B.

The recess 13A is where the striker 2 is fitted. The latch 13B is a member that locks the striker 2 fitted in the recess 13A. The engagement of the latch 13B and the striker 2 is released when a releasing device (not shown) is operated.

The lock device 13 can switch the mode between a lock mode in which the latch 13B locks the striker 2 and an unlock mode in which the lock mode is released. The position of the latch 13B is different between the lock mode and the unlock mode.

As shown in FIG. 1, at least one lock device 13 is disposed on each of the two posts 12. In the present embodiment, the lock device 13 is disposed on an upper end side and a lower end side of each of the posts 12.

The lock devices 13 disposed on the lower end side of the posts 12 are situated on the base 11 side as seen from the longitudinal midpoint of the posts 12. Each of the lock devices 13 is housed in the corresponding post 12 (see FIG. 3).

### <2.2. Guide Member>

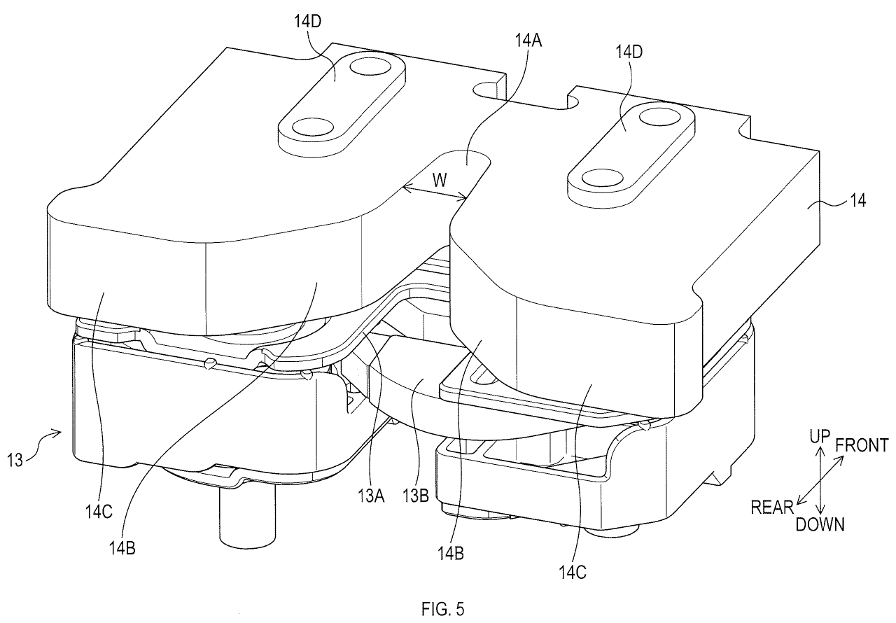

As shown in FIG. 5, the guide member 14 is situated close to the lock device 13. The guide member 14 guides the striker 2 to a portion of the recess 13A where the striker 2 can be locked with the latch 13B (hereinafter, such a portion is also referred to as locking portion).

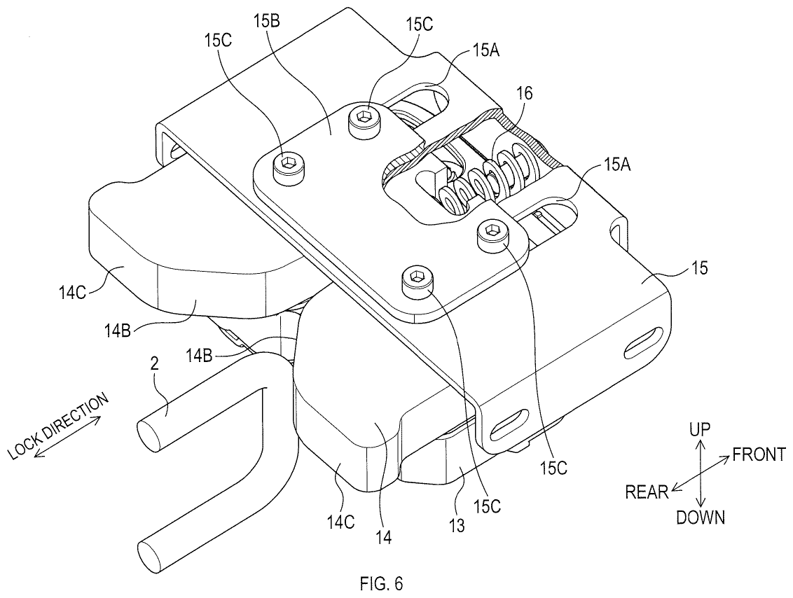

More specifically, as shown in FIG. 6, the guide member 14 guides the striker 2 to the locking portion of the lock device 13 by slidably contacting with the striker 2 when the post 12 (see FIG. 1, FIG. 3, etc.) approaches the striker 2.

Thus, as shown in FIG. 5, the guide member 14 includes a recess 14A for guiding the striker 2. The recess 14A is a concave dented from a rear end of the guide member 14 towards the front side of the guide member 14.

At the open side of the recess 14A, in other words, the rear end of the guide member 14, a slope 14B is disposed. The slope 14B inclines with respect to a normal direction of a contact surface 14C such that the width W of the opening is reduced towards the front side of the guide member 14.

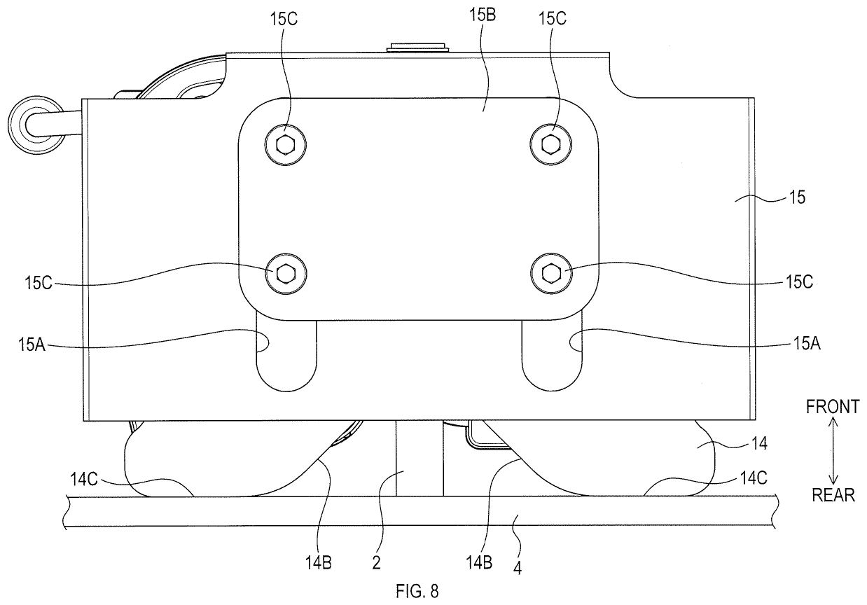

The contact surface 14C is disposed at the rear end of the guide member 14, in other words, at the open side of the recess 14A. As shown in FIG. 8, the contact surface 14C contacts the wall 4 when the striker 2 is locked with the lock device 13.

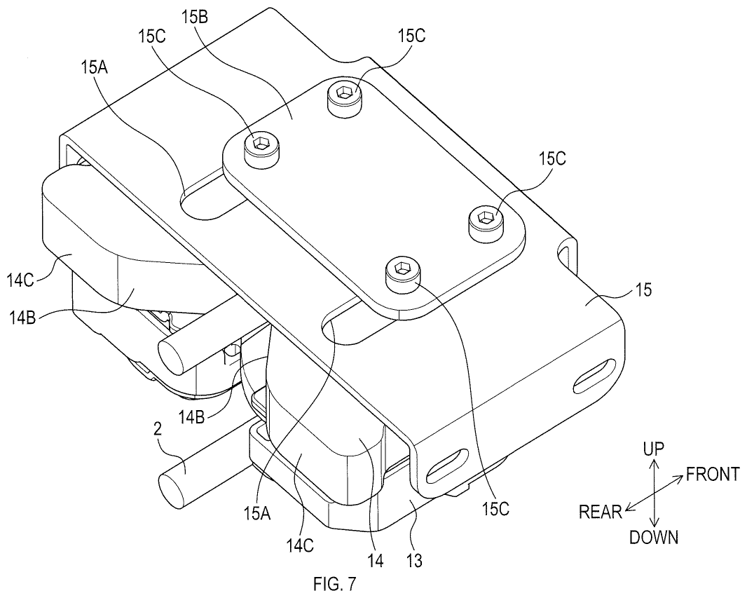

As shown in FIG. 6 and FIG. 7, the guide member 14 is displaceable with respect to the lock device 13 fixed to the post 12 in directions orthogonal to the contact surface 14C (in the present embodiment, front-rear directions). Such directions (in the present embodiment, the front-rear directions) are also referred to as lock directions.

More specifically, as shown in FIG. 3, the guide member 14 is supported by a bracket 15 such that the guide member 14 is displaceable with respect to the bracket 15. The bracket 15 is fixed to the post 12 and includes elongated holes 15A.

The major-axis directions of the elongated holes 15A match with directions along which the guide member 14 can be displaced. Bosses 14D (see FIG. 5) disposed on the guide member 14 are slidably fitted into the elongated holes 15A. The bosses 14D are protrusions projected from a wall surface (in the present embodiment, an upper surface) of the guide member 14.

On a side of the bracket 15 opposite the side facing the guide member 14, in other words, on the upper surface side of the bracket 15, a plate 15B is disposed as shown in FIG. 3. The guide member 14 is fixed to the plate 15B by fastening bolts 15C.

This yields a state in which the bracket 15 is interposed between the plate 15B and the guide member 14. The guide member 14 can be displaced with respect to the lock device 13 in the front-rear directions (or, in the lock directions) by the bosses 14D being displaced in the elongated holes 15A by sliding.

As shown in FIG. 6, a spring 16 is disposed on a front end side of the guide member 14. The spring 16 is an elastic element that causes an elastic force against a pressing force acting on the contact surface 14C to act on the guide member 14.

The front end side of the guide member 14 is situated on the opposite side of the contact surface 14C in the direction of displacement of the guide member 14 (in FIG. 6, the front-rear directions and the lock directions). The pressing force acting on the contact surface 14C is a reaction force from the wall 4 that is generated when the contact surface 14C collides with the wall 4 when a user presses the wheeled platform 10 towards the wall 4 to fix the wheeled platform 10 with the strikers 2.

Accordingly, the guide member 14 is configured such that the contact surface 14C comes in contact with the wall 4 firstly when the posts 12 and the strikers 2 approach each other. More specifically, the wheeled platform system 1 is configured such that the contact surface 14C is situated at the rearmost end regardless of the state of displacement (in other words, attached position) of the guide member 14.

### <3. Power Receiving Device>

### <3.1 Outline of Power Receiving Device>

The power receiving device 20 is a device for supplying electric power from a power supply unit (in the present embodiment, a vehicle (not shown)) to the wheeled platform 10. The power receiving device 20 includes an outlet (not shown) for a power cord plug (not shown) of the object 3, such as a refrigerator.

As shown in FIG. 1, the power receiving device 20 is disposed at a position near a given lock device 13 among two or more lock devices 13. More specifically, the power receiving device 20 is housed in the post 12 while being situated adjacent to the given lock device 13 at a position displaced from the given lock device 13 in up-down directions (more specifically, in a downward direction).

### <3.2 Configuration of Power Receiving Device>

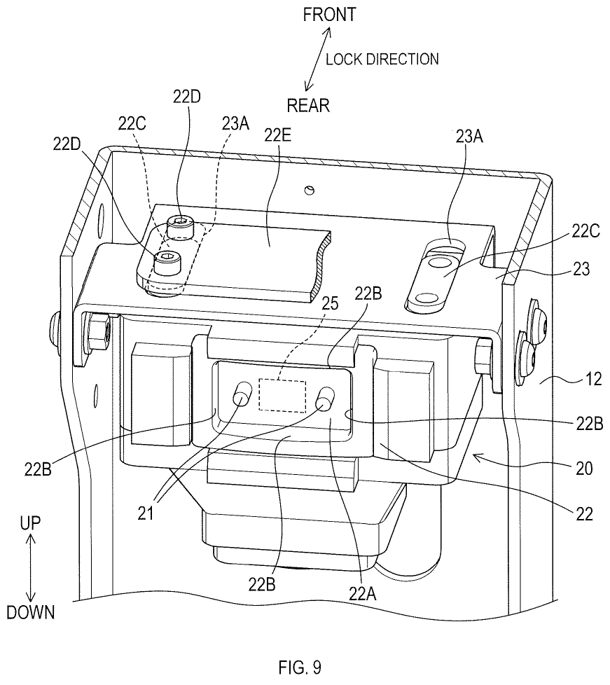

As shown in FIG. 9, the power receiving device 20 includes wheeled platform side terminals 21, a wheeled platform side terminal holder 22, and a holder bracket 23.

### <Wheeled Platform Side Terminal>

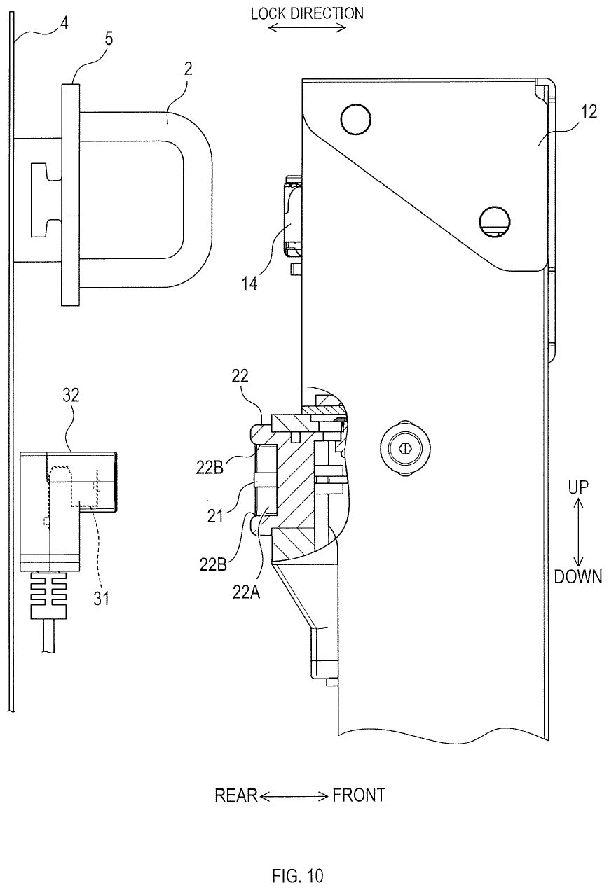

The wheeled platform side terminals 21 are electrodes that are electrically contactable with fixed side terminals 31 (see FIG. 2) disposed on the wall 4. The fixed side terminals 31 are power supply electrodes electrically coupled to the power supply unit. As shown in FIG. 10, the fixed side terminals 31 are held by a fixed side terminal holder 32.

The fixed side terminal holder 32 is held by a fixed power receiving device 30 (see FIG. 2) fixed to the wall 4. The wheeled platform side terminals 21 are situated at a position that allows the wheeled platform side terminals 21 to come into contact with the fixed side terminals 31 when the strikers 2 are locked with the latches 13B (when the lock devices 13 are locked with the strikers 2).

More specifically, as shown in FIG. 10, in a state where the wheeled platform 10 is not fixed to the strikers 2 by locking, in other words, in a state where the strikers 2 are situated away from the guide members 14, the wheeled platform side terminals 21 are also situated away from the fixed side terminals 31.

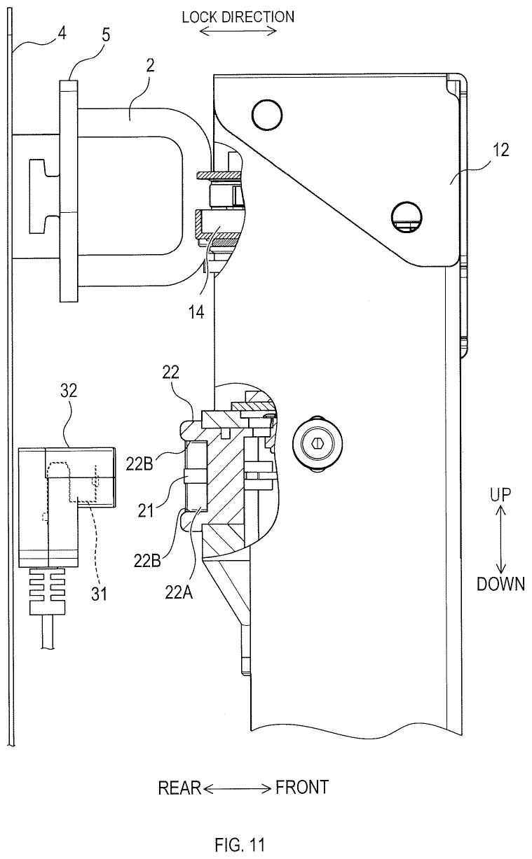

As shown in FIG. 11. when the wheeled platform 10 moves from the front side to the rear side in the lock directions, and the posts 12 approach the wall 4, the guide members 14 come in contact with the strikers 2 before the wheeled platform side terminals 21 come in contact with the fixed side terminals 31.

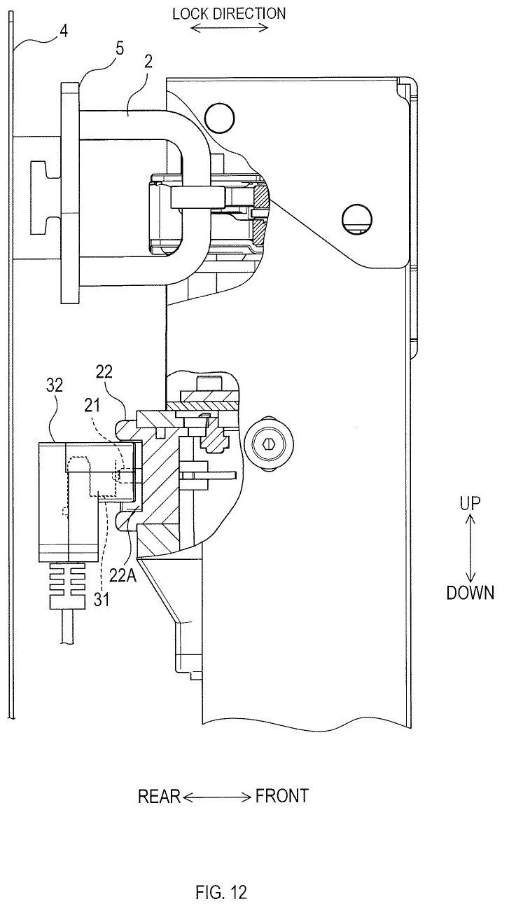

Furthermore, as shown in FIG. 12, when the wheeled platform 10 approaches the wall 4, the strikers 2 are locked with the latches 13B, and at the same time, the wheeled platform side terminals 21 come in contact with the fixed side terminals 31. This provides a state in which the power supply unit is electrically coupled to the power receiving device 20 of the wheeled platform 10.

### <Wheeled Platform Side Terminal Holder>

The wheeled platform side terminal holder 22 holds the wheeled platform side terminals 21. As shown in FIG. 12, the wheeled platform side terminal holder 22 includes a recess 22A. The recess 22A is an indentation into which a part of the fixed side terminal holder 32 can be fitted.

Thus, the recess 22A is formed from a leading end of the wheeled platform side terminal holder 22 towards the front side in the lock directions (the front-rear directions). As shown in FIG. 10, a tapered portion 22B is disposed at the entrance of the recess 22A.

The tapered portion 22B includes a surface inclined with respect to the lock directions so that the opening area increases towards the entrance of the recess 22A. The tapered portion 22B includes a circular arc surface and is formed over the entire outer rim of the entrance of the recess 22A (see FIG. 9).

### <Supporting Structure of Wheeled Platform Side Terminal Holder>

The wheeled platform side terminal holder 22 is slidable in the lock directions. In other words, the wheeled platform side terminals 21 are slidable in the lock directions. More specifically, the wheeled platform side terminal holder 22 is slidable in the lock directions with respect to the holder bracket 23 (see FIG. 9) and is coupled to the holder bracket 23.

As shown in FIG. 9, the holder bracket 23 is fixed to the post 12. The holder bracket 23 includes elongated holes 23A. The major-axis directions of the elongated holes 23A match with the lock directions. Bosses 22C disposed on the wheeled platform side terminal holder 22 are slidably fitted into the elongated holes 23A.

The bosses 22C are protrusions projected from a wall (in the present embodiment, an upper surface) of the wheeled platform side terminal holder 22. A plate 22E is disposed on a side of the holder bracket 23 opposite the side facing the wheeled platform side terminal holder 22, in other words, on the upper surface side of the holder bracket 23.

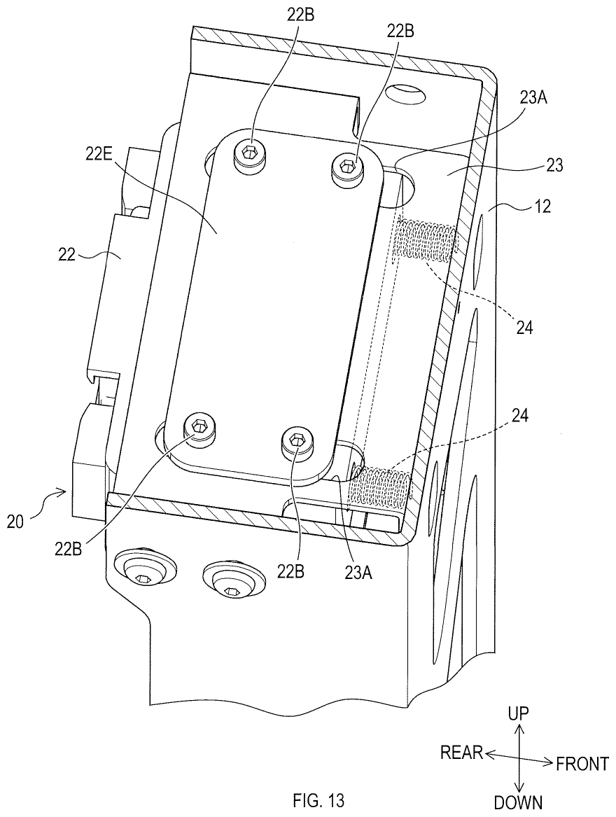

As shown in FIG. 13, the plate 22E is fixed to the wheeled platform side terminal holder 22 by fastening bolts 22D (in the present embodiment, four bolts 22D). Thus, the holder bracket 23 is interposed between the plate 22E and the wheeled platform side terminal holder 22.

The wheeled platform side terminal holder 22 can be displaced in the lock directions (in other words, the front-rear directions) with respect to the holder bracket 23 by the bosses 22C being displaced in the elongated holes 23A by sliding.

A spring 24 is disposed between the wheeled platform side terminal holder 22 and the post 12. The spring 24 causes an elastic force imposed rearward in the lock directions (the front-rear directions), in other words, an elastic force towards the wall 4 (hereinafter referred to as pressing force) to act on the wheeled platform side terminals 21.

In a state where at least the wheeled platform side terminals 21 come in contact with the fixed side terminals 31, and the wheeled platform 10 further approaches the wall 4 so that the strikers 2 engage with the latches 13B (hereinafter referred to as engaged contact state), the spring 24 is elastically deformed, and the pressing force is generated.

When the position of the wheeled platform side terminal holder 22 in the engaged contact state is called a connection completed position, and the direction from the fixed side terminals 31 towards the wheeled platform side terminals 21 (forward direction of the lock directions (the front-rear directions)) is called a backside direction, the wheeled platform side terminal holder 22 is slidable over the connection completed position to a position situated further in the backside direction.

The slidable dimension of the wheeled platform side terminal holder 22 is greater than the dimension from the position where the fixed side terminals 31 and the wheeled platform side terminals 21 approach each other and come into contact with each other to the connection completed position situated further in the backside direction.

### <Relation Between Wheeled Platform Side Terminal Holder and Fixed Side Terminal Holder>

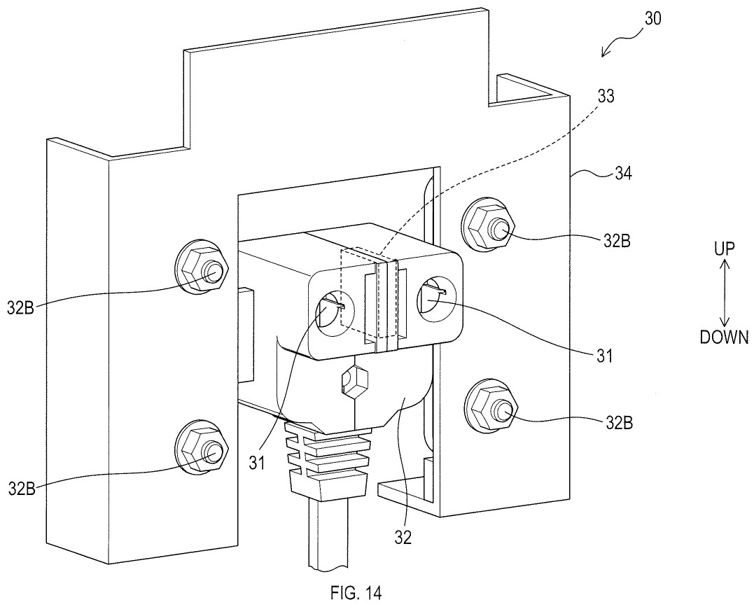

At least one of the wheeled platform side terminal holder 22 or the fixed side terminal holder 32 includes a magnet 33 (see FIG. 14), and the other one of the wheeled platform side terminal holder 22 or the fixed side terminal holder 32 includes an attractor 25 made of a ferromagnetic material (see FIG. 9). In the present embodiment, the fixed side terminal holder 32 includes the magnet 33, and the wheeled platform side terminal holder 22 includes the attractor 25.

Thus, in the present embodiment, a magnetic attraction force generated between the magnet 33 and the attractor 25 when the wheeled platform side terminals 21 come in contact with the fixed side terminals 31 acts as a magnetic attraction force that increases a contact surface pressure between the wheeled platform side terminals 21 and the fixed side terminals 31.

### <4. Fixed Power Receiving Device>

As shown in FIG. 14, the fixed power receiving device 30 includes the fixed side terminal holder 32 (including the fixed side terminals 31) and a bracket 34. The bracket 34 is a member fixed to the wall 4 via a fixed rail 5 or the like.

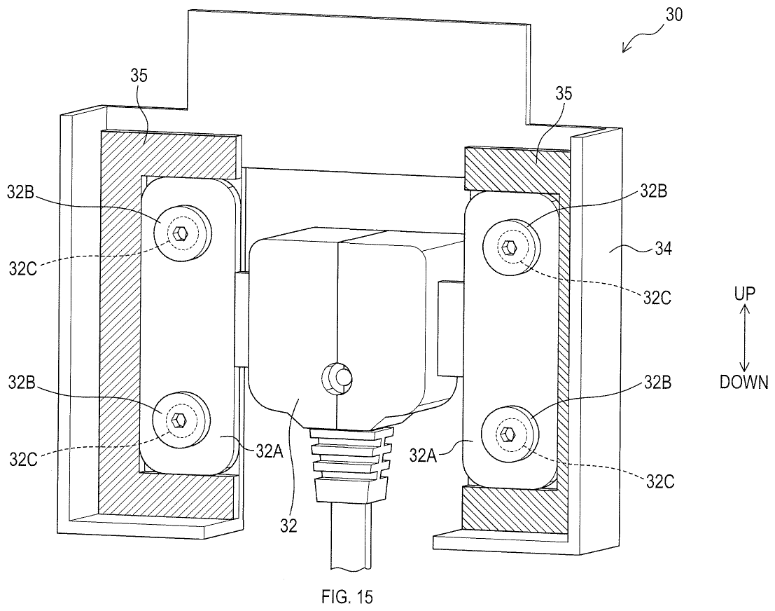

The fixed side terminal holder 32 is supported by the bracket 34 so as to be displaceable in a direction orthogonal to the lock directions. In other words, as shown in FIG. 15, the fixed side terminal holder 32 includes at least one stay 32A (in the present embodiment, two stays 32A).

Each of the stays 32A includes a through hole 32C for a shoulder bolt 32B for fixing to pass through. The diameter dimension of the through hole 32C is greater than the large diameter portion of the shoulder bolt 32B.

Thus, each of the stays 32A can be displaced with respect to the shoulder bolt 32B in a direction orthogonal to longitudinal directions of the shoulder bolt 32B. In the present embodiment, the longitudinal directions matches with the lock directions. Accordingly, each of the stays 32A can be displaced in a direction orthogonal to the lock directions (hereinafter referred to as vertical directions).

Each of the stays 32A includes at least one of the shoulder bolt 32B and the through hole 32C (in the present embodiment, two or more of the shoulder bolts 32B and the through holes 32C). Each of the shoulder bolts 32B passes through the stay 32A and is fixed to the bracket 34 (see FIG. 14).

The bracket 34 includes restriction members 35. The restriction members 35 cause an elastic force to limit vertical displacement of the stays 32A to act on the stays 32A. The restriction members 35 in the present embodiment are rubber-made plate members.

### <5. Characteristics of Wheeled Platform>

The wheeled platform 10 is guided by the guide member 14 and locked to the striker 2 that is fixed to a given position. At this time, the position of the wheeled platform side terminals 21 automatically matches with the position of the fixed side terminals 31. Accordingly, fixing of the wheeled platform 10 and connection of the wheeled platform side terminals 21 with the fixed side terminals 31 are achieved at the same time.

The wheeled platform side terminals 21 are slidable in the lock directions, and the wheeled platform 10 includes the spring 24 that causes the elastic force in the lock directions to act on the wheeled platform side terminals 21. Accordingly, in the wheeled platform 10, dispersion of positions of the wheeled platform side terminals 21 and the fixed side terminals 31 in the lock directions can be absorbed.

In the wheeled platform 10, in a state where the wheeled platform side terminals 21 come in contact with the fixed side terminals 31 and the striker 2 is engaged with the latch 13B, the spring 24 is elastically deformed. Accordingly, in the wheeled platform 10, the contact surface pressure between the wheeled platform side terminals 21 and the fixed side terminals 31 can be increased when the wheeled platform side terminals 21 come in contact with the fixed side terminals 31.

The wheeled platform side terminals 21 of the wheeled platform 10 are slidable over the connection completed position to a position situated further in the backside direction. This can inhibit damages on the wheeled platform side terminals 21 due to a large load acting on the wheeled platform side terminals 21 when the wheeled platform side terminals 21 largely deviate with respect to the fixed side terminals 31 in a direction orthogonal to the lock directions.

The wheeled platform system 1 is configured such that the magnetic attraction force that increases the contact surface pressure between the wheeled platform side terminals 21 and the fixed side terminals 31 is generated between the wheeled platform side terminal holder 22 holding the wheeled platform side terminals 21 and the fixed side terminal holder 32 holding the fixed side terminals 31 when the wheeled platform side terminals 21 come in contact with the fixed side terminals 31.

Accordingly, the elastic force of the spring 24 and the magnetic attraction force act on contact portions of the wheeled platform side terminals 21 and the fixed side terminals 31, which increases the contact surface pressure between the wheeled platform side terminals 21 and the fixed side terminals 31. This enables the wheeled platform side terminals 21 and the fixed side terminals 31 to be infallibly coupled to each other.

In the wheeled platform system 1, at least one of the wheeled platform side terminal holder 22 or the fixed side terminal holder 32 (in the present embodiment, the wheeled platform side terminal holder 22) is displaceable in the vertical directions. Accordingly, even in a case where the wheeled platform side terminals 21 deviate with respect to the fixed side terminals 31 in a direction orthogonal to the lock directions, such deviation can be absorbed.

Consequently, even in a case where the wheeled platform side terminals 21 deviate with respect to the fixed side terminals 31 in the vertical directions, the wheeled platform side terminals 21 and the fixed side terminals 31 can infallibly come in contact with each other.

The wheeled platform side terminal holder 22 includes the recess 22A into which a part of the fixed side terminal holder 32 can be fitted. The tapered portion 22B is disposed at the entrance of the recess 22A. The opening area of the tapered portion 22B increases toward the entrance of the recess 22A.

This enables the wheeled platform side terminals 21 and the fixed side terminals 31 to infallibly come in contact with each other even in a case where the wheeled platform side terminals 21 deviates with respect to the fixed side terminals 31 in a direction orthogonal to the lock directions.

### Second Embodiment

The wheeled platform side terminal holder 22 according to the aforementioned first embodiment was immovable in the vertical directions with respect to the post 12. In contrast, the wheeled platform side terminal holder 22 according to the second embodiment is configured to be displaceable in the vertical directions.

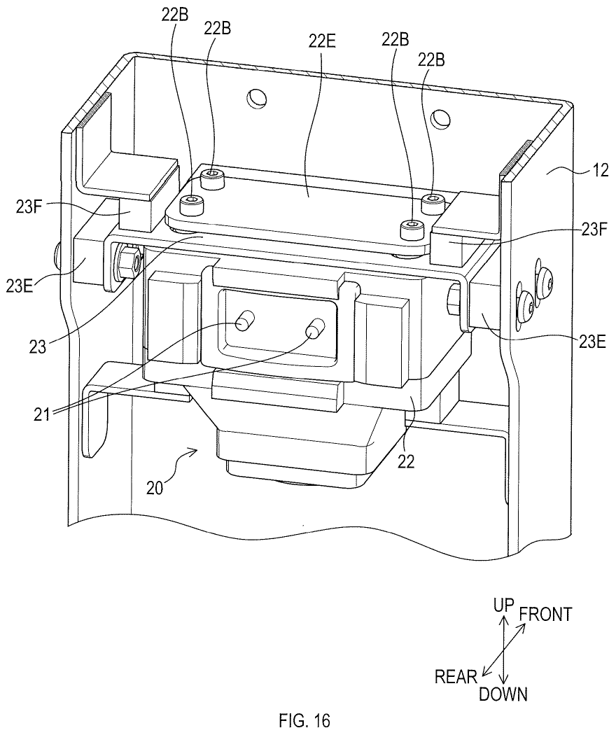

In other words, as shown in FIG. 16, the holder bracket 23 according to the second embodiment is fixed to the post 12 via elastically deformable support members 23E, 23F made of rubber or the like. The support members 23E, 23F are directly or indirectly supported by the post 12.

The support members 23E allow the holder bracket 23 to be displaced in horizontal directions and prohibit the holder bracket 23 from being displaced in the horizontal directions over predetermined dimensions.

The support members 23F allow the holder bracket 23 to be displaced in the vertical directions and prohibit the holder bracket 23 from being displaced in the vertical directions over predetermined dimensions. Accordingly, similar to the wheeled platform system 1 in the first embodiment, even in a case where the wheeled platform side terminals 21 deviate with respect to the fixed side terminals 31 in the vertical directions, in other words, the directions orthogonal to the lock directions, such deviation can be absorbed.

The above explanation describes differences from the wheeled platform system 1 and the wheeled platform 10 according to the aforementioned first embodiment. Therefore, elements and the like of the second embodiment identical to the first embodiment are given the same reference numerals as those of the first embodiment. Accordingly, redundant explanations are omitted in the second embodiment.

### Other Embodiments

In the aforementioned first and second embodiments, the wheeled platform side terminal holder 22 includes the tapered portion 22B. Nevertheless, the present disclosure is not limited thereto. For example, it may be configured such that the fixed side terminal holder 32 includes a recess into which a part of the wheeled platform side terminal holder 22 can be fitted, and a tapered portion is formed at the entrance of the recess.

The wheeled platform side terminals 21 and the fixed side terminals 31 according to the aforementioned first and second embodiments are terminals for supplying electric power. Nevertheless, the present disclosure is not limited thereto. For example, the wheeled platform side terminals 21 and the fixed side terminals 31 may be terminals for transmitting a signal such as an electric signal and an optical signal.

In the aforementioned first and second embodiments, at least one of the wheeled platform side terminal holder 22 or the fixed side terminal holder 32 is displaceable in the vertical directions. Nevertheless, the present disclosure is not limited thereto. For example, the wheeled platform side terminal holder 22 and the fixed side terminal holder 32 may be configured to be undisplaceable in the vertical directions.

In the aforementioned first and second embodiments, the wheeled platform side terminals 21, in other words, the wheeled platform side terminal holder 22, is slidable in the lock directions. Nevertheless, the present disclosure is not limited thereto. For example, the fixed side terminal holder 32 and the wheeled platform side terminal holder 22 may be slidable in the lock directions.

In the aforementioned first and second embodiments, the attractor 25 is disposed in the wheeled platform side terminal holder 22, and the magnet 33 is disposed in the fixed side terminal holder 32. Nevertheless, the present disclosure is not limited thereto. For example, it may be configured such that the attractor 25 and the magnet 33 are eliminated; or such that the attractor 25 is disposed in the fixed side terminal holder 32, and the magnet 33 is disposed in the wheeled platform side terminal holder 22.

The wheeled platform 10 according to the aforementioned first and second embodiments includes the spring 24 that causes an elastic force in the lock directions to act on the wheeled platform side terminals 21, in other words, on the wheeled platform side terminal holder 22. Nevertheless, the present disclosure is not limited thereto. For example, the spring 24 may be eliminated, and it may be configured such that the fixed side terminals 31 are configured to be displaceable in the lock directions, and that the wheeled platform 10 may include a spring that causes an elastic force in the lock directions to act on the fixed side terminals 31, in other words, the fixed side terminal holder 32.

In the wheeled platform system according to the aforementioned first and second embodiments, the strikers 2 and the fixed power receiving device 30 are disposed on the wall 4. Nevertheless, the present disclosure is not limited thereto. For example, it may be configured such that at least one of the strikers 2 or the fixed power receiving device 30 is disposed on the floor.

In the aforementioned first and second embodiments, the wheeled platform side terminals 21 include projected members, and the fixed side terminals 31 include S-shaped flat springs that can come in contact with the projected members. Nevertheless, the present disclosure is not limited thereto. For example, the fixed side terminals 31 may be configured to include projected members, and the wheeled platform side terminals 21 may be configured to include S-shaped flat springs.

Furthermore, the present disclosure is only required to coincide with the gist of the disclosure described in the aforementioned embodiments and thus should not be limited to the aforementioned embodiments. Therefore, the present disclosure may include a configuration obtained by combining at least two of the aforementioned embodiments, or a configuration obtained by eliminating either one of the elements in the drawings or the elements described with reference numerals in the aforementioned embodiments.

What is claimed is:

1. A wheeled platform comprising:
a base on which an object is placed;
wheels attached to the base;
a lock device including a latch that is lockable to a striker that is fixed;
a guide member configured to guide the striker to a position where the striker is lockable to the latch;
and
a wheeled platform side terminal contactable with a fixed side terminal disposed on a member to which the striker is fixed, the wheeled platform side terminal being disposed at a position where the wheeled platform side terminal is contactable with the fixed side terminal when the latch locks the striker,
the wheeled platform being configured such that the guide member comes in contact with the striker before the wheeled platform side terminal comes in contact with the fixed side terminal.

2. The wheeled platform according to claim 1, further comprising:
a spring configured to cause an elastic force in lock directions to act on the wheeled platform side terminal, the lock directions being directions in which the base is moved when the latch and the striker are locked to each other,
wherein the wheeled platform side terminal is slidable in the lock directions.

3. The wheeled platform according to claim 2,
wherein, in a state where the wheeled platform side terminal contacts the fixed side terminal and where the striker and the latch are locked to each other, the spring is elastically deformed.

4. The wheeled platform according to claim 3,
wherein, in a case where a position of the wheeled platform side terminal when the wheeled platform side terminal contacts the fixed side terminal and when the striker and the latch are locked to each other is a connection completed position, and a direction from the fixed side terminal towards the wheeled platform side terminal is a backside direction, the wheeled platform side terminal is slidable over the connection completed position to a position situated further in the backside direction.

5. The wheeled platform according to claim 4,
wherein a magnetic attraction force that enhances a contact surface pressure between the wheeled platform side terminal and the fixed side terminal is generated between a wheeled platform side terminal holder that holds the wheeled platform side terminal and a fixed side terminal holder that holds the fixed side terminal when the wheeled platform side terminal contacts the fixed side terminal.

6. The wheeled platform according to claim 1, further comprising:
a spring configured to cause an elastic force oriented from the wheeled platform side terminal to the fixed side terminal to act on the wheeled platform side terminal,
wherein, when directions in which the base moves when the latch and the striker are locked to each other are lock directions,
the wheeled platform side terminal is slidable in the lock directions; and
a magnetic attraction force that enhances a contact surface pressure between the wheeled platform side terminal and the fixed side terminal is generated between a wheeled platform side terminal holder that holds the wheeled platform side terminal and a fixed side terminal holder that holds the fixed side terminal when the wheeled platform side terminal contacts the fixed side terminal.

7. The wheeled platform according to claim 6,
wherein the wheeled platform side terminal holder is displaceable in directions orthogonal to the lock directions.

8. The wheeled platform according to claim 6,
wherein the wheeled platform side terminal holder includes a recess in which a part of the fixed side terminal holder is fittable,
wherein a tapered portion is disposed at an entrance of the recess, and
wherein an opening area of the tapered portion increases toward the entrance of the recess.

9. A wheeled platform system comprising:
a wheeled platform;
a striker that is fixed;
a fixed side terminal disposed on a member to which the striker is fixed;
a fixed side terminal holder configured to hold the fixed side terminal;
a lock device disposed on the wheeled platform and including a latch that is lockable to the striker;
a guide member disposed on the wheeled platform and configured to guide the striker to a position where the striker is lockable to the latch;
a wheeled platform side terminal disposed on the wheeled platform and situated in a position contactable with the fixed side terminal when the latch locks the striker;
a wheeled platform side terminal holder disposed on the wheeled platform and configured to hold the wheeled platform side terminal;
a spring disposed on at least either one of the wheeled platform or the member to which the striker is fixed and configured to cause an elastic force oriented to enhance a contact surface pressure between the wheeled platform side terminal and the fixed side terminal to act on at least one of the wheeled platform side terminal or the fixed side terminal; and
a magnet disposed on at least either one of the wheeled platform side terminal holder or the fixed side terminal holder and configured to generate a magnetic attraction force that enhances a contact surface pressure between the wheeled platform side terminal and the fixed side terminal when the wheeled platform side terminal contacts the fixed side terminal;
wherein, when directions in which the base is moved when the latch and the striker are locked to each other are lock directions, at least one of the wheeled platform side terminal or the fixed side terminal holder is slidable in the lock directions, and
wherein the wheeled platform is configured such that the guide member contacts the striker before the wheeled platform side terminal contacts the fixed side terminal.

10. The wheeled platform system according to claim 9,
wherein at least one of the wheeled platform side terminal holder and the fixed side terminal holder is displaceable in directions orthogonal to the lock directions,
wherein at least one of the wheeled platform side terminal holder or the fixed side terminal holder includes a recess in which a part of an other one of the wheeled platform side terminal holder or the fixed side terminal holder is fittable,
wherein a tapered portion is disposed at an entrance of the recess, and
wherein an opening area of the tapered portion increases toward the entrance of the recess.
